(19) United States
(12) Patent Application Publication
(10) Pub. No.: US 2008/0181616 A1
(43) Pub. Date: Jul. 31, 2008

(54) WAVELENGTH DISPERSION COMPENSATION CONTROL DEVICE AND METHOD THEREOF

(75) Inventor: Hitoshi Takeshita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/926,317

(22) Filed: Oct. 29, 2007

(30) Foreign Application Priority Data
Jan. 31, 2007 (JP) 2007/020277

(51) Int. Cl. H04B 10/12

(52) U.S. Cl. 398/147

(57) ABSTRACT

A wavelength dispersion compensation control device includes an error correction circuit for correcting a code error of a signal from an optical transmission line, a variable wavelength dispersion compensator for changing wavelength dispersion characteristics based on this error correction information and performing a dispersion compensation of the optical transmission line, and a control circuit for performing a control of the variable wavelength dispersion compensator based on the number of error corrections that is the error correction information so that this error correction number becomes the minimum, wherein the control circuit, when scanning the dispersion at predetermined step widths in a variable range of the variable wavelength dispersion compensator, increases a dispersion setting value at the variable wavelength dispersion compensator while the step width is set as ΔD1 when an error correction success and failure information that is the error correction information is failure, and increases the dispersion setting value while the step width is set as ΔD2 (ΔD1≧ΔD2) when the error correction success and failure information is success.

### INCORPORATION BY REFERENCE

This application is based upon and claims the benefit of priority from Japanese patent application No. 2006-020277 filed on Jan. 31, 2007, the disclosure of which is incorporated herein in its entirety by reference.

### BACKGROUND OF THE INVENTION

1. Field of the Invention

The present invention relates to a wavelength dispersion compensation control device and the method thereof, and in particular, it relates to a wavelength dispersion compensation control method of an optical fiber in an optical communication system.

2. Description of the Related Art

With the increase of communication capacities in recent years, the practical application of a class of a transmission rate over 10 Gb/s per optical signal channel is expected to be imminent. In such a high speed optical transmission line, to compensate a waveform distortion due to optical signal transmission and reduce a code error rate due to signal transmission, compensation of the wavelength dispersion characteristics of the optical fiber transmission line becomes indispensable. Heretofore, by inserting a dispersion compensation fiber (DCF) having inverse characteristics of the wavelength dispersion characteristics of the optical fiber transmission line into the transmission line, the wavelength dispersion compensation has been performed.

This wavelength dispersion amount can be obtained by a product of the length of the optical fiber and the primary dispersion coefficient. The dispersion coefficient of the DCF has an opposite sign to the dispersion coefficient of the optical transmission line, and therefore, the wavelength dispersion compensation is performed by inserting the DCF having a length sufficient to offset the wavelength dispersion amount of the optical fiber transmission line into the transmission line. In proportion to the transmission rate, a demand requiring length adjustment accuracy of the DCF becomes tough. Further, the length adjustment of the DCF is required every optical signal channel, thereby causing a problem that a lot of trouble is taken with the adjustment when the number of optical signal channels increases.

Hence, a method has been proposed, in which a control of the variable wavelength dispersion compensator is performed so as to minimize a code error rate of the reception signal by using the variable wavelength dispersion compensator, and the wavelength dispersion compensation of the transmission line is automatically performed. Such technology is, for example, disclosed in Japanese Patent Application Laid-Open Publication No. 2001-077756 (Patent Document 1).

However, in the technique as disclosed in the Patent Document 1, there is a problem as described below. When the wavelength dispersion amount of the optical transmission line is unknown, there is a problem that an extremely time-consuming operation is required for finding a code error rate in all variable ranges of the variable wavelength dispersion compensator and finding the wavelength dispersion value in which the code error rate becomes the minimum from among the measured points. Until an appropriate wavelength dispersion value is set to the variable wavelength dispersion compensator, its optical transmission line is not usable. Consequently, with this method, it is often the case that only the reduction of the human hours by the automation of the wavelength dispersion compensation of the optical transmission line is realized, and sufficient time reduction is not obtained.

To speed up the automatic wavelength dispersion compensation, it is conceivable to reduce the measuring points of the code error rate and the measuring time of the code error rate in the variable range of the variable wavelength dispersion compensator. For example, referring to Japanese Patent Application Laid-Open Publication No. 2004-236097 (Patent Document 2), the technique is disclosed in which the variable wavelength dispersion compensator is caused to scan in its variable range, and when the signal synchronization is unable to be established, a step width for changing a wavelength dispersion (herein after referred to as “wavelength dispersion change step width”) is large so as to reduce the measuring points of the code error rate, thereby increasing a wavelength dispersion compensation control speed. However, in this method of simply switching the wavelength dispersion change step depending on the success and failure of the signal synchronization, it is often the case that an error occurs in the control result depending on the wavelength dispersion characteristics of the transmission signal.

The case in which such an error occurs will be described below in detail by using FIGS. 5 and 6. The axis of abscissas in the figures represents wave dispersion, and the axis of ordinate represents the correction number of the errors in an FEC (Forward Error Correction), respectively. The relationship between a dispersion compensation amount by the variable wavelength dispersion compensator and the number of error corrections in the FEC shows different characteristics as shown in FIG. 5 and FIG. 6 according to the transmission line and the optical signal characteristics. FIG. 5 shows general characteristics in the case where the number of error corrections in the FEC successively change according to the dispersion compensation amount, and these characteristics are in the shape of a parabola.

FIG. 6 shows the case where the number of error corrections in the FEC is not observed in the range of the predetermined dispersion compensation amount because the S/N ratio of the reception signal is high or the like. In FIG. 5, while there is only one minimum point, in FIG. 6, a minimum point is not specifiable at one point. In the case of the reception state as shown in FIG. 6, for example, even when the wavelength dispersion value fluctuates, it is generally practiced that a median point of the multiple minimum points is taken as a wavelength dispersion setting value so that the number of error corrections in the FEC do not sharply deteriorate.

However, the simple switching of the wavelength dispersion step width by the method of the Patent Document 2 does not allow the number of error corrections to be converged into the median point of the multiple local minimum points, and therefore, in spite of the setting the number of error corrections to the wavelength dispersion value in which the error becomes the minimum, an error sharply increases by the wavelength dispersion fluctuation due to the temperature change and the like, and therefore, it is highly likely that the communication is disabled.

This situation will be described in detail by using FIG. 7. When a scan is made from a point (a) to a point (e) in the variable range of the variable wavelength dispersion compensator, in the vicinity of the point (a), since the signal synchronization is not established, the error becomes the maximum value. Assuming that the signal synchronization is established at the point (b) for the first time, in the segments from (a) to (b), the scan comes to be performed by a large wavelength dispersion change step width ΔD1. At the point (b), the signal synchronization is detected, so that the wavelength dispersion change step width is switched to ΔD2 (≦ΔD1), and at the point (d), the signal synchronization is not established, and therefore, the step returns to the ΔD1 step width again.

The problem of this operation is that, in spite of the fact that the wavelength dispersion value capable of signal synchronization prior to the point (b) exists, the signal synchronization detection is omitted at the ΔD1 step, and therefore, the segment capable of the signal synchronization prior to the point (b) is unable to be detected. Hence, an apparent signal synchronizable segment becomes shortened, and a segment median point to be set to the variable wavelength dispersion compensator is shifted to the point (d) side.

When the wavelength dispersion characteristics of the transmission line or the transmission optical signal are changed for some factors, a bathtub like curve of FIG. 7 is shifted to either of the left or the right. On the other hand, since the wavelength dispersion setting value of the variable wavelength dispersion compensator remains fixed, assuming that the bathtub curve is shifted to the left side, either an error sharply increases or the signal becomes out of synchronization. When the wavelength dispersion setting value of the variable wavelength dispersion compensator is shifted to the point (d) side, it is highly likely that the signal quality deterioration occurs.

In general, the measurement of transmission error becomes more accurate when the measurement time is longer. Consequently, when the signal synchronization can be established, the error measurement time is made longer, so that a convergent value in the wavelength dispersion setting of the variable wavelength dispersion compensator can be found more highly accurately. However, it is not efficient to conduct an error measurement for a long time likewise when the signal synchronization is not established.

### SUMMARY

An exemplary object of the invention is to provide a wavelength dispersion compensation control device and the method thereof capable of performing a control of the variable wavelength dispersion compensator at a high speed and a high accuracy so as to minimize a code error rate by the signal transmission.

A device according to an exemplary aspect of the invention is a wavelength dispersion compensation control device including:

an error correction circuit for correcting a code error of a signal from an optical transmission line,

a variable wavelength dispersion compensator for changing wavelength dispersion characteristics based on this error correction information and performing a dispersion compensation of the optical transmission line, and

a control circuit for performing a control of the variable wavelength dispersion compensator based on the number of error corrections that is the error correction information so that this error correction number becomes the minimum,

wherein the control circuit, when scanning the dispersion at predetermined step widths in a variable range of the variable wavelength dispersion compensator, increases a dispersion setting value at the variable wavelength dispersion compensator while the step width is set as ΔD1 when an error correction success and failure information that is said error correction information is failure, and increases the dispersion setting value while the step width is set as ΔD2 (ΔD1≧ΔD2) when the error correction success and failure information is success.

A wavelength dispersion compensation control method according to an exemplary aspect of the invention is a wavelength dispersion compensation control method, including:

correcting a code error of a signal from an optical transmission line,

performing the dispersion compensation of the optical transmission line by changing the wavelength dispersion characteristics based on this error correction information, and

performing a control (herein after referred to as control process) of the dispersion compensation so as to minimize this number of error corrections based on the number of error corrections serving as the error correction information,

wherein the control process, when scanning the dispersion at predetermined step widths in a variable range of a variable wavelength dispersion compensator, increases a dispersion setting value at the variable wavelength dispersion compensator while the step width is set as ΔD1 when an error correction success and failure information that is the error correction information is failure, and increases the dispersion setting value while the step width is set as ΔD2 (ΔD1≧ΔD2) when the error correction success and failure information is success.

The operation of the present invention will be described. The dispersion compensation control circuit scans a variable range of the variable wavelength dispersion compensator, and the monitoring of the number of error corrections by the FEC and the error correction success and failure information (hereinafter, referred to as FAIL flag) by the FEC is performed, and a control of monotonically increasing and changing (scanning) the wavelength dispersion value of the variable wavelength dispersion compensator is performed by ΔD1 when the error correction success and failure information is failure (hereinafter, referred to as FAIL=1), and by ΔD2 (ΔD2≦ΔD1) when the error correction success and failure information is success (hereinafter, referred to as FAIL=0) respectively. Moreover, assuming that a monitoring time in a certain wavelength dispersion value of the variable wavelength dispersion compensator is taken as T, when FAIL=1 is detected, the scanning is sped up by changing the wavelength dispersion value of the variable wavelength dispersion compensator into the next wavelength dispersion value even when the monitoring time is below T.

Further, when FAIL=1 is changed to FAIL=0, before switching the wavelength dispersion change step width from ΔD1 to ΔD2, the wavelength dispersion value is once turned back by ΔD1−ΔD2, and then, switched to ΔD2 so as to improve the convergent accuracy on the wavelength dispersion value, thereby enabling the high speed and highly accurate wavelength dispersion compensation to be realized.

### BRIEF DESCRIPTION OF THE DRAWINGS

FIG. 1 is a functional block diagram of one embodiment of the present invention;

FIG. 2 is a flowchart to describe the operation of one embodiment of the present invention;

FIG. 3 is a block diagram showing a specific example corresponding to one embodiment of the present invention;

FIG. 4 is a functional block diagram of another embodiment of the present invention;

FIG. 5 is a diagram showing one example of the relationship between wavelength dispersion and the number of error corrections at an FEC;

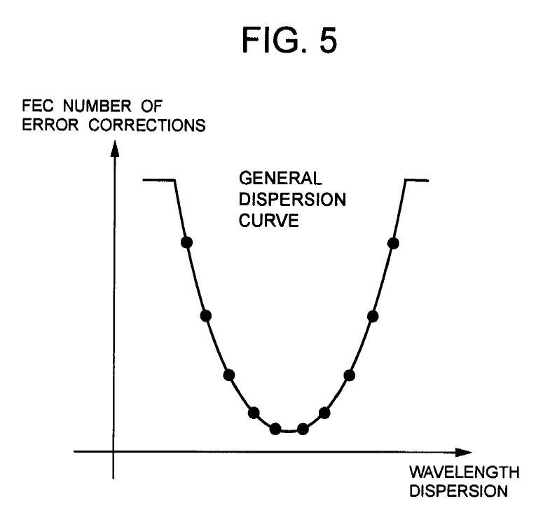

FIG. 6 is a diagram showing another example of the relationship between wavelength dispersion and the number of error corrections in the FEC; and

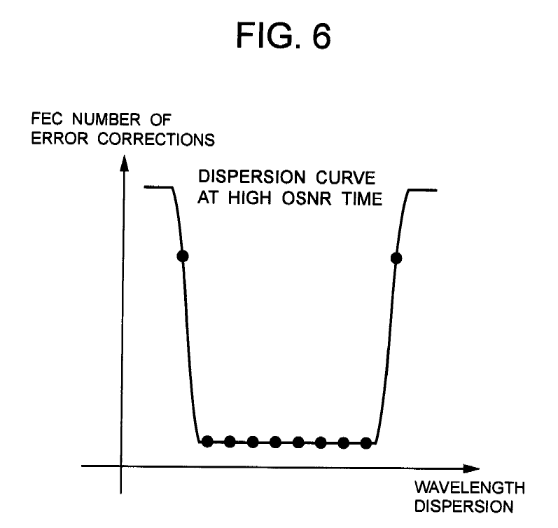

FIG. 7 is a diagram to describe the operation of the wavelength dispersion compensation in Patent Document 2.

### EXEMPLARY EMBODIMENTS

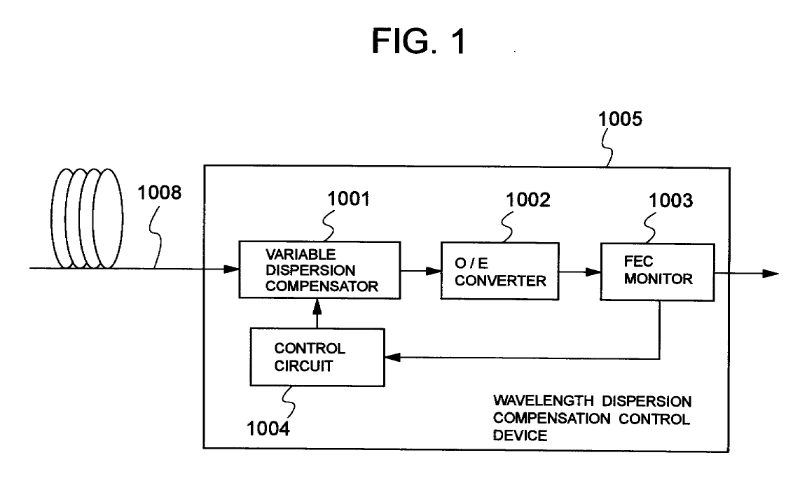

Hereinafter, referring to the drawings, exemplary embodiments of the present invention will be described in detail. FIG. 1 is a functional block diagram of one embodiment of the present invention. In FIG. 1, an optical signal is inputted to a variable wavelength dispersion compensator 1001 from an optical fiber 1008. The optical signal having passed through the variable wavelength dispersion compensator 1001 is led to an O/E converter 1002, and after that, passes through an FEC monitor 1003, and is outputted outside of a wavelength dispersion compensation control device 1005. The monitoring result outputted from the FEC monitor 1003 is inputted to a control circuit 1004, and the control circuit 1004, by using the monitoring result, outputs a control signal to the variable wavelength dispersion compensator 1001.

Hereinafter, the operation of the wavelength dispersion compensation control device configured as described above will be described. The optical signal inputted to the wavelength dispersion compensation control device 1005 from the optical fiber 1008 is added with wavelength dispersion when passing through the variable wavelength dispersion compensator 1001. A wavelength dispersion amount to be added is controlled by the control circuit 1004. The optical signal having passed the variable wavelength dispersion compensator 1001 is converted into an electrical signal from the optical signal by the O/E converter 1002, and is led to the FEC monitor 1003. In the FEC monitor 1003, the number of error corrections in the FEC obtained from an FEC frame header and a FAIL flag (the meaning of FAIL=1/0 is as described in the above operation) representing the presence or absence of the FAIL which is the success and failure of the error correction are monitored, and the result is transmitted to the control circuit 1004.

When a residual dispersion value (Din) in an output point of the optical fiber 1008 and a wavelength dispersion amount (Dc) to be added at the variable wavelength dispersion compensator 1001 have opposite signs to each other and are equal in value, that is, when a residual dispersion value Dout (=Din+Dc)=0 in the output point of the variable wavelength dispersion compensator 1001, signal deterioration becomes the minimum, and therefore, the number of error corrections monitored in the FEC monitor 1003 also becomes the minimum.

Conversely, when Dout>>0 or Dout<<0, FAIL=1, and therefore, only when the error correction is successful, it looks like FAIL=0 from the control circuit 1004, and otherwise, it looks like FAIL=1.

In the wavelength dispersion compensation control device 1005, based on the above described FAIL, the wavelength dispersion change step width of the variable wavelength dispersion compensator 1001 is switched, thereby performing a high speed scan, and the variable wavelength dispersion compensator 1001 is set to a wavelength dispersion value in which the number of error corrections in the FEC becomes the minimum. Hereinafter, this scan operation is referred to as training, and the wavelength dispersion value in which the number of error corrections in the FEC becomes the minimum is referred to as training convergent value.

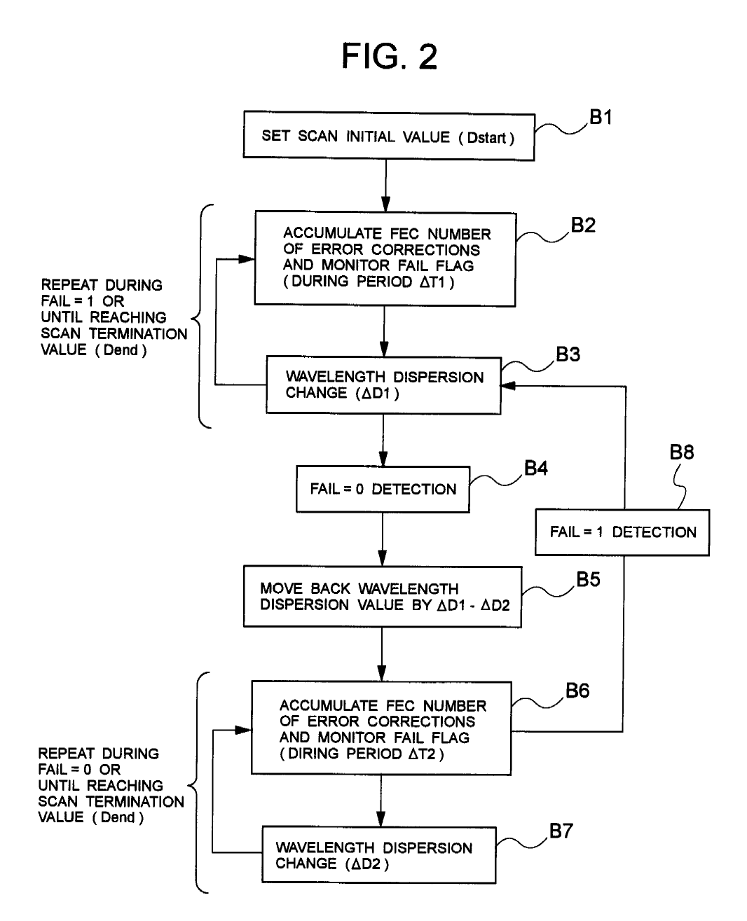

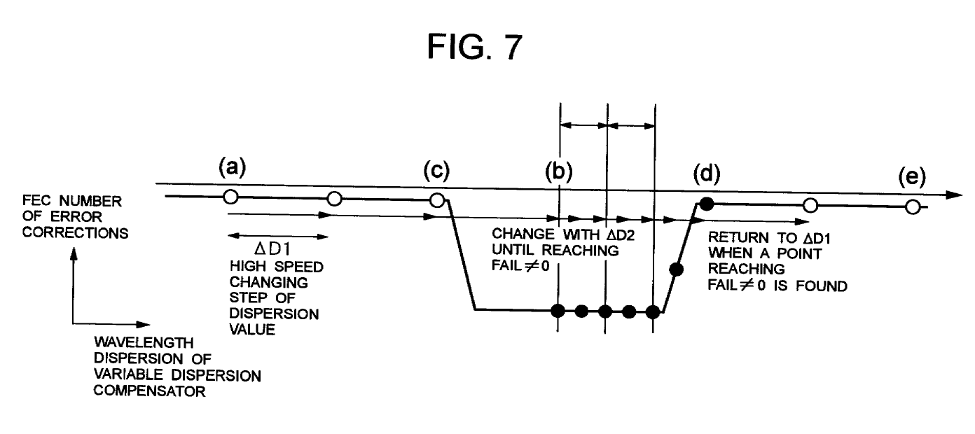

The detail of the training operation will be described in detail by using FIGS. 2 and 7. In FIG. 7, the control circuit 1004 generates a command to the variable wavelength dispersion compensator 1001, so that the training is started from a point (a) to a point (e) in the variable range of the variable wavelength dispersion compensator. In the vicinity of the point (a), FAIL=1, and therefore, the scan is performed at the wavelength dispersion change step width ΔD1. Assuming that FAIL=0 at the point (b) for the first time, in the segment from (a) to (b), the scan would be performed at a large wavelength dispersion change step width ΔD1.

By detecting FAIL=0 at the point (b), the wavelength dispersion change step width is switched to ΔD2(≦ΔD1). At this time, the step width is not changed to the direction of (d), but turned back to the direction of (a) once by ΔD1−ΔD2, and from (c), the scan is re-started to the direction of (b) at the ΔD2 step width. Since FAIL=1 at (d), the wavelength dispersion change step width returns to the ΔD1 step width again, and performs a scan up to (e). In this case, since there is a segment of a successive minimum number of error corrections in the FEC in the segment from (c) to (d), the median point of this segment is calculated as a training convergent value. Ultimately, the calculated convergent value is set to the variable wavelength dispersion compensator 1001 and the training operation is completed.

In this training operation, when the wavelength dispersion is changed by the ΔD1 step width, an operation of turning back by ΔD1−ΔD2, and after that, switching to the ΔD2 step width is performed when the FEC frame synchronization is detected for the first time, and therefore, in spite of FAIL=0, the segment in which the scan by the ΔD2 step width is not performed does not exist. Consequently, the training convergent value is not shifted to the direction of (d), and a median point of the error correction number minimum segment at a true FEC can be calculated.

FIG. 2 is a state transition diagram of the training operation. Step B1 shows that the control circuit 1004 sets the minimum value (initial value) Dstart of a variable range to the variable wavelength dispersion compensator 1001, and is in a state of generating the training start command. Step B2 shows a state in which the accumulation of the number of error corrections during the period ΔT1 is performed, and “1” or “0” of the FAIL flag is monitored. After the elapse of the period ΔT1, at step B3, an operation of increasing the wavelength dispersion setting value of the variable wavelength dispersion compensator 1001 by ΔD1 is performed. When FAIL=1 or during a period until reaching the maximum value Dend of the variable range, the operations of monitoring the number of error corrections during the period ΔT1 and changing the wavelength dispersion by ΔD1 are repeated.

When FAIL=0, step B4 transits to step B5. At step B5, the wavelength dispersion value is turned back from the wavelength dispersion setting current value of the variable wavelength dispersion compensator 1001 by (ΔD1−ΔD2). At step B6, the accumulation of the number of error corrections in the FEC during the period ΔT2 (ΔT2≧ΔT1) and the FAIL monitoring are performed. At step B7, an operation of increasing the wavelength dispersion setting value of the variable wavelength dispersion compensator 1001 by ΔD2 is performed.

When FAIL=0 or during a period until reaching the maximum value Dend of the variable range, the operations of monitoring the number of error corrections during the period ΔT2 and changing the wavelength dispersion by ΔD2 are repeated. At step B7, when FAIL=1 is detected within the period ΔT2, even when the monitoring time is less than the period ΔT2, the step immediately transits to step B3, and returns to the scan at ΔD1 step again. As a result of repeating the operation of changing the wavelength dispersion of the variable wavelength dispersion compensator 1001 by the ΔD1 step or ΔD2, the scan is terminated at a point having reached the maximum value Dend of the variable range, and the training convergent value is calculated, and the variable wavelength dispersion compensator 1001 is set to the training convergent value, thereby terminating the training operation.

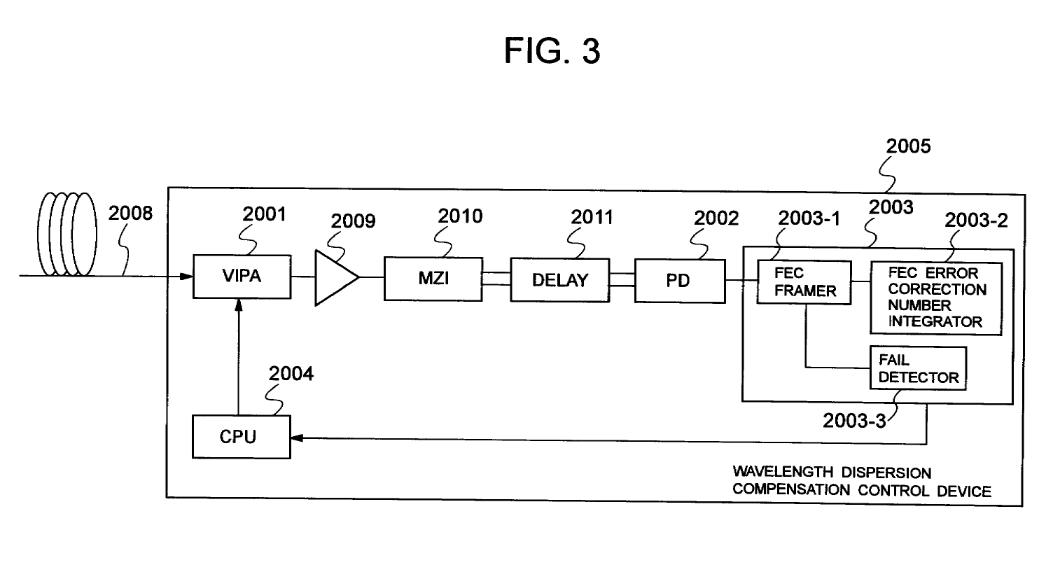

An example corresponding to this one embodiment will be described below with reference to FIG. 3. In FIG. 3, an example of the case is shown where, as the variable wavelength dispersion compensator, a VIPA (Virtual Imaged Phased Array) is used, and an RZ-DPSK (Return to Zero-Differential Phase Shift Keying) modulated light is inputted.

In FIG. 3, the optical signal is inputted to a VIPA 2001 from an optical fiber 2008. The optical signal having passed through the VIPA 2001 is led to an optical amplifier 2009, a 1 bit delay interferometer (MZI) 2010, a delay adjustor 2011, a PD (Photo Detector) 2002, and an FEC monitor 2003 in this order. The FEC monitor 2003 is configured by an FEC framer 2003-1 to perform the detection of an FEC frame, an error correction number integrator 2003-2 extracting the error correction number in the FEC from an FEC frame header and performing an accumulation for the predetermined fixed time (ΔT), and a FAIL detector 2003-3 similarly extracting the FAIL information from the FEC frame header and determining the presence or absence of the existence of the FAIL within ΔT.

The error correction number in the FEC and the FAIL information generated within the period ΔT from the FEC monitor 2003 are outputted to a CPU (Central Processing Unit) 2004. The CPU 2004, based on the information inputted from the FEC monitor 2003, outputs a control signal to the VIPA 2001.

Next, the operation of the wavelength dispersion compensator of FIG. 3 will be described. The FEC frame-formatted optical signal which is inputted to the wavelength dispersion compensation control device 2005 from the optical fiber 2008 is added with wave dispersion when passing through the VIPA 2001. A wavelength dispersion amount to be added is controlled by the CPU 2004. The optical signal having passed through the VIPA 2001 is inputted to the optical amplifier 2009, and is amplified in light intensity to compensate an insertion loss of the VIPA 2001. The output of the optical amplifier 2009 is led to a 1 bit delay interferometer 2010, and after optical phase/intensity modulation conversion is performed, it is inputted to the delay adjustor 2011.

The delay adjustor 2011 performs delay adjustment of two optical paths reaching the PD 2002 from the 1 bit delay interferometer 2010. The optical signal converted into the intensity modulation is converted into an electrical signal from the optical signal at the PD 2002, and is led to the FEC monitor 2003. In the FEC monitor 2003, the built-in FEC framer 2003-1 performs FEC frame detection. The error correction number integrator 2003-2 performs an extraction of the error correction number from the FEC frame header every one frame, and performs the accumulation of the number of error corrections during the predetermined fixed period ΔT. Further, the FAIL detector 2003-3 extracts the FAIL information from the FEC frame during the period ΔT, and performs determination of the presence or absence of the FAIL.

When a wavelength dispersion amount (Din) possessed by the optical signal inputted from the optical fiber 2008 and a wavelength dispersion amount (Dc) added by the VIPA 2001 have opposite sighs to each other, and are equal in value, that is, when the wavelength dispersion amount of the optical signal outputted from the VIPA 2001 is (=Din+Dc=) 0, the signal deterioration by a primary wavelength dispersion becomes the minimum, and therefore, the error value monitored by the FEC monitor 2003 becomes also the minimum. Conversely, when Dout>>0 or Dout<<0, the signal deterioration is large, and therefore, FAIL=1, and it looks like FAIL=1 from the CPU 2004.

In the wavelength dispersion compensation control device 2005, based on the above described FAIL, the wavelength dispersion change step width of the VIPA 2001 is switched so as to perform a high speed scan, and the wavelength dispersion compensation control device 1005 (2005) is set to the wavelength dispersion value in which the error correction number in the FEC becomes the minimum. This scan operation shall be hereinafter referred to as training, and the wavelength dispersion value in which the number of error corrections in the FEC becomes the minimum shall be referred to as a training convergent value.

The detail of the training operation will be described in detail by using FIGS. 7 and 2. In FIG. 7, the CPU 2004 generates a command to the VIPA 2001, thereby the training is started from a point (a) to a point (e) in the variable range of the variable wavelength dispersion compensator. In the vicinity of (a), the FEC frame synchronization is not established, and therefore, the number of error corrections in the FEC becomes the maximum value. Assuming that the signal synchronization is established at (b) for the first time, in the segment from (a) to (b), the scan comes to be performed by a large wavelength dispersion change step width ΔD1. At (b), the FEC frame synchronization is detected, so that the wavelength dispersion change step width is switched to ΔD2 (≦ΔD1).

At this time, the step is not changed to the direction of (d), but turned back to the direction of (a) once by (ΔD1−ΔD2), and from (c), the scan is re-started to the direction of (b) by the step width ΔD2. Since the FEC frame synchronization is not established at (d), the step returns to the step width ΔD1 again, and performs a scan up to (e). In FIG. 7, since a segment of a successive minimum number of error corrections in the FEC exists in the segment (c) to (d), the median point of this segment is calculated as a training convergent value. Ultimately, the calculated convergent value is set to the variable wavelength dispersion compensator 1003 and the training operation is completed.

In this training operation, when the wavelength dispersion is changed by the ΔD1 step width, an operation of turning back by ΔD1−ΔD2 when the FEC frame synchronization is detected for the first time, and after that, switching to the ΔD2 step width is performed, and therefore, as shown in FIG. 7, in spite of the fact that the FEC frame synchronization can be established, the segment in which the scan at the ΔD2 step width is not performed does not exist. Consequently, the training convergent value is not shifted to the direction of (d), and a median point of the error correction number minimum segment at the true FEC can be calculated.

FIG. 2 is a state transition view of the training operation. Step B1 shows that the CPU 2004 sets the minimum value Dstart of the variable range to the variable wavelength dispersion compensator 2001, and is in a state of generating the training start command. The step B2 is in a state in which the accumulation of the number of error corrections during the period ΔT1 is performed, and the presence or absence of the FAIL flag is monitored. After the elapse of the period ΔT1, at step B3, an operation of increasing the wavelength dispersion setting value of the variable wavelength dispersion compensator 2001 by ΔD1 is performed.

When FAIL=1 or during a period until reaching the maximum value Dend of the variable range, the operations of monitoring the number of error corrections during the period ΔT1 and changing the wavelength dispersion by the step width ΔD1 are repeated. When FAIL=1 is not detected, that is, when FAIL=0, step B4 transits to step B5. At step B5, the step is turned back from the wavelength dispersion setting current value of the variable wavelength dispersion compensator 2001 by (ΔD1−ΔD2). At step B6, the error correction number accumulation in the FEC during the period ΔT2 (ΔT2≧ΔT1) and FAIL are monitored. At step B7, an operation of increasing the wavelength dispersion setting value of the variable wavelength dispersion compensator 2001 by ΔD2 is performed.

When FAIL=0 or during a period until reaching the maximum value Dend of the variable range, the operations of monitoring the number of error corrections during the period ΔT2 and changing the wavelength dispersion by step width ΔD2 are repeated. At step B7, when FAIL=1 is detected within the period ΔT2, even when the monitoring time is less than the period ΔT2, the step immediately transits to step B3, and returns to the scan at the ΔD1 step again. As a result of repeating the operations of changing the wavelength dispersion of the variable wavelength dispersion compensator 2001 by ΔD1 or A D2, the scan is terminated at a point having reached the maximum value Dend of the variable range, and the training convergent value is calculated, and the variable wavelength dispersion compensator 2001 is set to the training convergent value, thereby terminating the training operation.

While a description has been made on the variable wavelength dispersion compensator with the VIPA taken as an example, the compensator may be the variable wavelength dispersion compensator of other systems such as FBG (Fiber Grating) type.

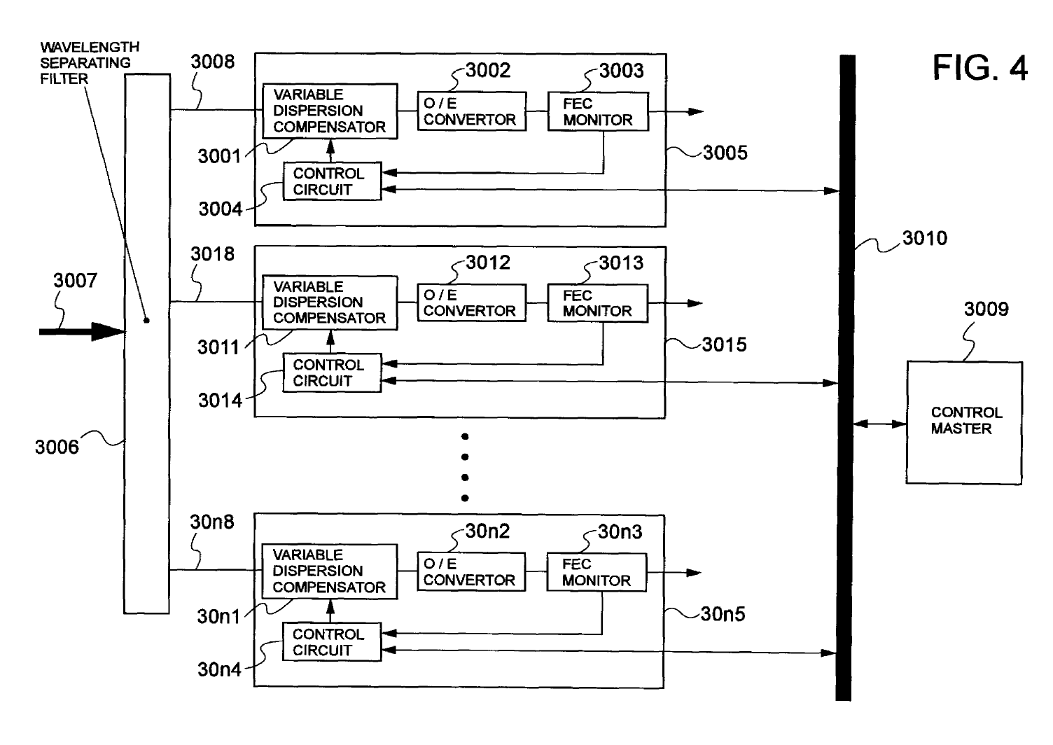

FIG. 4 is a functional block diagram of another embodiment of the present invention. This embodiment is an example in which the wavelength dispersion compensation control is performed every optical signal wavelength, and by associating a plurality of wavelength dispersion compensation control devices, an execution of the wavelength dispersion compensation control of the wavelength multiple optical signals is realized at a high speed and a high accuracy with less loading.

N-wavelength-multiplexed (n is an integer of 2 or greater) optical signals are wavelength-separated by a wavelength separating filter 3006 from the optical fiber 3007. The optical signal of a wavelength 1 is led by an optical fiber 3008, and is inputted to a wavelength dispersion compensation control device 3005. Likewise, the optical signal of a wavelength n is led by an optical fiber 30n8, and is inputted to a wavelength dispersion compensation control device 30n5. Here, the values of the wavelengths 1 to n shall be taken as the known values.

In the wavelength dispersion compensator 3005, as described in FIG. 1, a variable wavelength dispersion compensator 3001 is set to a Dopt1 at a high speed and a high accuracy for the optical signal of the wavelength 1 by training. Further, the control circuit 3004 gives a notice to a control master 3009 through a controlling bus 3010 about the Dopt1. The wavelength dispersion value is different every wavelength, and with a wavelength λ taken as a variable, it is generally known to be established in the following formula (1). (For example, see ITU-TG.656 Appendix 1.2).

D(λ)=L(D1550+S1550(λ−1550)) [Ps/nm] (1)

In this formula (1), L represents an optical fiber length, D1550 a wavelength dispersion value (known constant) in the wavelength 1550 nm, and S1550 a secondary wavelength dispersion coefficient (known constant). Assuming that the training convergent value at the time of the wavelength 1 (λ1) is Dopt1 and the training convergent value at the time of the wavelength n (λn) is Doptn, and the following formulas (2) and (3) are established.

Dopt1=L(D1550+S1550(λ1−1550)) (2)

Doptn=L(D1550+S1550(λn−1550)) (3)

A formula (4) will be derived from the formulas (2) and (3).

Doptn=Dopt1(D1550+S(λn−1550))/(D1150+S(λn−1550)) (4)

From the formula (4), Doptn can be theoretically determined if Dopt1 is known. The control master 3009 calculates Doptn from Dopt1 obtained from the wavelength dispersion compensation control device 3005 according to the formula (4), and transmits Dopt2 to Doptn through the control bus 3010 to the wavelength dispersion compensation control devices 3005 to 30n5, respectively.

The wavelength dispersion compensation control devices 3015 to 30n5 can set the training convergent values for the wavelength 2 to the wavelength n to the variable wavelength dispersion compensators 3011 to 30n1 without performing the training. Consequently, no matter how much the number of wavelengths n increases, the training only needs to be executed once, and the wavelength dispersion compensation of the wavelength multiplexed optical signal can be performed with less loading.

In this case, Dopt2-Doptn are logically calculated by formula (4). However, in order to obtain true values Dopt2-Doptn which are higher precision, each of the control circuits 3014-30n4 performs a fine adjustment. For example, regarding the second (k=2) wavelength, a value calculated by using Dopt1 is a target value Dopt2′, and the control circuit 3014 scans only a segment of D2s<Dopt2′<D2e (a range from D2s to D2e is narrow than the variable range of the variable wavelength dispersion compensator 3011) at a ΔD2 step width, so that the true value Dopt2, which is the wavelength dispersion setting value of the second variable wavelength dispersion compensator 3011, in which the error correction number for the second wavelength signal becomes the minimum, is obtains. Each of third to n-th control circuits 3024-30n4 performs an operation in the same manner as described above.

When the transmission signal speed becomes over 10 Gbps class, the need arises to set Dopt to a high accuracy. From the formula (3), Dopt is different every wavelength, and therefore, in the system of performing the wavelength dispersion compensation collectively every wave, there is a possibility that, while some wavelength is capable of transmitting signals, other wavelengths are not capable of transmitting signals. Consequently, as shown in FIG. 4, the wavelength dispersion compensation control must be performed every wavelength.

A first exemplary advantage according to the invention is that a speeding up is made feasible. The reason comes from the fact that the useless error correction number measuring points in the FEC are thinned out based on the FAIL information, and moreover, the error correction number accumulation time in the FEC is shortened, thereby enabling the training to be sped up.

A second exemplary advantage according to the invention is that the convergent value calculation is highly accurate. The reason comes from the fact that, when the wavelength dispersion step during the training is switched from a rough step to a fine step, the step turns back once, and then, re-starts the scan by the fine step, and therefore, even when the plurality of successive error correction number minimum points in the FEC exist, the number of error corrections can be converged into the median point of the successive error correction number minimum points in the FEC.

A third exemplary advantage according to the invention is that stability is high. The reason comes from the fact that the training convergent value can be accurately set to the error correction number minimum point in the FEC, and therefore, even when the number of error corrections in the FEC increases due to the fluctuation of the optical signal and the wavelength dispersion characteristics of the optical transmission line, the increased amount thereof can be confined to the minimum, and the possibility of a trouble occurring in the signal transmission can be suppressed low.

A fourth exemplary advantage according to the invention is that the configuration is simple. The reason comes from the fact that the invention can be realized by a simple configuration of the variable wavelength dispersion compensator, the O/E converter, the FEC monitor circuit and the control circuit.

A fifth exemplary advantage according to the invention is that general versatility is high. The reason comes from the fact thin the FEC frame format capable of accommodating a variety of signal formats is used.

A sixth exemplary advantage according to the invention is that scalability is high. The reason comes from the fact that even when the transmission signal speed becomes fast, the same configuration is applicable, and even when wavelength multiplexed density becomes high, the wavelength dispersion compensation control device of the same structure may be prepared every wavelength, and the same configuration is applicable without depending on time/degree of wavelength multiplexing.

A seventh exemplary advantage according to the invention is that the operation cost can be reduced. The reason comes from the fact that, by using the variable wavelength dispersion compensator, the number of error corrections is automatically set to the wavelength dispersion value in which the number of error corrections in the FEC becomes the minimum, and therefore, the operation in which dispersion value adjustment by a length adjustment of the DCF is performed by manual procedures can be automated, and the number of working processes can be reduced.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A wavelength dispersion compensation control device comprising:
an error correction circuit for correcting a code error of a signal from an optical transmission line,
a variable wavelength dispersion compensator for changing wavelength dispersion characteristics based on this error correction information and performing a dispersion compensation of said optical transmission line, and
a control circuit for performing a control of said variable wavelength dispersion compensator based on the number of error corrections that is said error correction information so that this error correction number becomes the minimum,
wherein said control circuit, when scanning the dispersion at predetermined step widths in a variable range of the variable wavelength dispersion compensator, increases a dispersion setting value at said variable wavelength dispersion compensator while the step width is set as ΔD1 when an error correction success and failure information that is said error correction information is failure, and increases the dispersion setting value while said step width is set as ΔD2 (ΔD1≧ΔD2) when said error correction success and failure information is success.

2. The wavelength dispersion compensation control device according to claim 1, wherein when it is detected that said error correction success and failure information is failure for a predetermined dispersion value in said variable wavelength dispersion compensator within a predetermined monitoring time T of a device for monitoring said number of error corrections required by said control circuit, said control circuit stops monitoring of said number of error corrections and switches to the next dispersion value.

3. The wavelength dispersion compensation control device according to claim 1, wherein, when said error correction success and failure information in the preceding setting value of said variable wavelength dispersion compensator is failure and moreover when said error correction success and failure information in the present setting value is success, said control circuit causes the next wavelength dispersion setting value to move back from the present setting value by (ΔD1−ΔD2), and moreover, sets said step width as ΔD2.

4. The wavelength dispersion compensation control device according to claim 1, wherein, when the setting value of said variable wavelength dispersion compensator in which said number of error corrections becomes the minimum has a plurality of successive points, said control circuit takes the median point of the plurality of these points as the smallest point.

5. The wavelength dispersion compensation control device according to claim 1, wherein the signal from said optical transmission line is a n-wavelength multiplexed optical signal (n≧2), and said variable wavelength dispersion compensator, said error correction circuit, and said control circuit are provided for each of these wavelengths.

6. The wavelength dispersion compensation control device according to claim 5, further comprising a control master circuit of collectively controlling n pieces of said control circuit, wherein, said control master circuit first controls the first control circuit to obtain a wavelength dispersion setting value D1 of the first variable wavelength dispersion compensator in which said number of error corrections becomes the minimum, obtains a wavelength dispersion setting value D2 of the second wavelength dispersion compensator by using the D1, and obtains a wavelength dispersion setting value Dk of the k-th wavelength dispersion compensator by using the Dk−1 of the k−1st wavelength dispersion compensator.

7. The wavelength dispersion compensation control device according to claim 6, wherein the second control circuit scans only a segment of D2s<D1<D2e (a range from D2s to D2e is narrower than the variable range of said variable wavelength dispersion compensator) at a ΔD2 step width, so that the wavelength dispersion setting value D2 of the second variable wavelength dispersion compensator in which said error correction number for the second wavelength signal becomes the minimum is obtained, and each of third to n-th control circuits performs an operation in the same manner.

8. A wavelength dispersion compensation control method, comprising:
correcting a code error of a signal from an optical transmission line,
performing the dispersion compensation of said optical transmission line by changing the wavelength dispersion characteristics based on this error correction information, and
performing a control (herein after referred to as control process) of said dispersion compensation so as to minimize this number of error corrections based on the number of error corrections serving as said error correction information,
wherein said control process, when scanning the dispersion at predetermined step widths in a variable range of a variable wavelength dispersion compensator, increases a dispersion setting value at said variable wavelength dispersion compensator while the step width is set as ΔD1 when an error correction success and failure information that is said error correction information is failure, and increases the dispersion setting value while the step width is set as ΔD2 (ΔD1≧ΔD2) when said error correction success and failure information is success.

9. The wavelength dispersion compensation control method according to claim 8, wherein when it is detected that said error correction success and failure information is failure for a predetermined dispersion value in said variable wavelength dispersion compensator within a predetermined monitoring time T of a device for monitoring said number of error corrections required by said control process, said control process stops monitoring of said number of error corrections and switches to the next dispersion value.

10. The wavelength dispersion compensation control method according to claim 8, wherein, when said error correction success and failure information in the preceding setting value of said performing the dispersion compensation is failure and moreover when said error correction success and failure information in the present setting value is success, said control process causes the next wavelength dispersion setting value to move back from the present setting value by (ΔD1−ΔD2), and moreover, sets said step width as ΔD2.

11. The wavelength dispersion compensation control method according to claim 8, wherein, when the setting value of said variable wavelength dispersion compensator in which said number of error corrections becomes the minimum has a plurality of successive points, said control process takes a median point of the plurality of these points as the smallest point.

12. The wavelength dispersion compensation control method according to claim 8, wherein the signal from said optical transmission line is a n-wavelength multiplexed optical signal (n≧2), and said variable wavelength dispersion compensator, an error correction circuit, and a control circuit are provided for each of these wavelengths.

13. The wavelength dispersion compensation control method according to claim 12, further comprising, collectively controlling n pieces of said control circuit, wherein, said collectively controlling n piece of said control process first controls a first control circuit to obtain a wavelength dispersion setting value D1 of the first variable wavelength dispersion compensator in which said number of error corrections becomes the minimum, obtains a wavelength dispersion setting value D2 of the second wavelength dispersion compensator by using the D1, and obtains a wavelength dispersion setting value Dk of the k-th wavelength dispersion compensator by using the Dk−1 of the k−1st wavelength dispersion compensator.

14. The wavelength dispersion compensation control method according to claim 13, wherein the second control circuit scans only a segment of D2s<D1<D2e (a range from D2s to D2e is narrower than the variable range of said variable wavelength dispersion compensator) at a ΔD2 step width, so that the wavelength dispersion setting value D2 of the second variable wavelength dispersion compensator in which said error correction number for the second wavelength signal becomes the minimum is obtained, and each of third to n-th control circuits performs an operation in the same manner.

15. A wavelength dispersion compensation control device comprising:
error correction means for correcting a code error of a signal from an optical transmission line,
variable wavelength dispersion compensation means for changing wavelength dispersion characteristics based on this error correction information, and
performing a dispersion compensation of said optical transmission line, and control means for performing a control of said variable wavelength dispersion compensation means based on the number of error corrections that is said error correction information so that this error correction number becomes the minimum,
wherein said control means, when scanning the dispersion at predetermined step widths in a variable range of the variable wavelength dispersion compensation means, increases a dispersion setting value at said variable wavelength dispersion compensation means while the step width is set as ΔD1 when an error correction success and failure information that is said error correction information is failure, and increases the dispersion setting value while said step width is set as ΔD2 (ΔD1≧ΔD2) when said error correction success and failure information is success.
